(19) United States
(12) Patent Application Publication
(10) Pub. No.: US 2025/0203305 A1
(43) Pub. Date: Jun. 19, 2025

(54) HARDWARE AUDIO MODIFICATION SYSTEM

(71) Applicant: ADVANCED MICRO DEVICES, INC., Santa Clara (CA)

(72) Inventors: Carl Kittredge Wakeland, Santa Clara, CA (US); Uma Sankara Rao Balla, Hyderabad (IN)

(21) Appl. No.: 18/539,629

(22) Filed: Dec. 14, 2023

(51) Int. Cl. H04R 29/00

(52) U.S. Cl. CPC H04R 29/001; H04R 2430/01; H04R 2499/13

(57) ABSTRACT

A processing system includes an error management circuit that detects errors at a plurality of processing circuits. When an error is detected at at least one processing circuit but not another processing circuit, an audio control circuit modifies audio data corresponding to processing circuits where errors are detected while maintaining audio availability of processing circuits where no error is detected. In some implementations, modifying the audio data mutes processing circuits where errors are detected.

### BACKGROUND

In some computing environments, such as in automobiles, a processing system executes multiple audio programs, wherein each audio program produces audio of at least one corresponding type. For example, in some cases an automobile processing system executes one audio program to produce audio regarding automobile status (e.g., safety alerts) and a different audio program to produce audio for entertainment (e.g., music). Failure of some audio programs, such as programs controlling safety alerts of an automobile, is a danger to a user and thus unacceptable. Failure of other programs, such as a program controlling operation of an entertainment system of the automobile, is only an inconvenience to the user and thus merely undesirable. In some environments, each of several audio programs is capable of sending data to a single, commonly used audio system such that audio corresponding to the audio program is played.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of a processing system that includes a hardware audio modification system in accordance with some implementations.

FIG. 2 is a block diagram of an example hardware audio modification system in accordance with some implementations.

FIG. 3 is a block diagram showing an example modification of audio data in a hardware audio modification system in accordance with some implementations.

FIG. 4 is a block diagram of a second example hardware audio modification system in accordance with some implementations.

FIG. 5 is a flow diagram of a method of modifying audio in accordance with some implementations.

### DETAILED DESCRIPTION

A processing system, such as a group of audio co-processing circuits executing a group of audio processes in an automobile, is implemented such that if one audio processing circuit experiences an error, the processing system continues to function, maintaining audio availability for processing circuits running other audio processes. As a result, in an automobile, if a non-critical audio process such as a process controlling audio for an entertainment system fails, the automobile still plays audio for an emergency telephone call. However, some errors cause an audio process to repeatedly send a set of data to an audio system (e.g., a speaker via an audio mixer), resulting in the audio system playing a corresponding sound or set of sounds repeatedly. In some cases, such sounds distress or distract a driver of the automobile, potentially causing additional problems.

As described herein, a hardware audio modification system modifies audio corresponding to processing circuits experiencing errors and maintains audio availability for other processing circuits. In some implementations, an error management circuit detects that an error has occurred at a processing circuit. In response to detecting an error, the error management circuit signals an audio control circuit, which fills one or more audio buffer circuits corresponding to the processing circuit with a predetermined value. As a result, when the one or more audio buffer circuits are read, audio corresponding to the predetermined value is played rather than audio corresponding to the value that was previously stored at the one or more audio buffer circuits. For example, in some implementations, the predetermined value is zero, meaning that the one or more audio buffer circuits are zero-filled. In the example, when the one or more audio buffers are read, resulting audio is muted. Accordingly, the processing system continues to function such that audio from processing circuits where errors have been detected is modified or muted, but audio availability is maintained for other processing circuits. Additionally, because the audio is controlled using hardware circuits as opposed to software, the audio is controlled more quickly, resulting in less time for an error to cause sounds a user or driver might hear.

As used herein, “maintaining audio availability” of a group of processing circuits refers to a processing system continuing to play audio resulting from audio data from the group of processing circuits if that audio data is received. In other words, sounds are not necessarily guaranteed to be created based on data from a processing circuit. However, if data written by the processing circuit corresponds to creating sounds, then those sounds are created, even if sounds corresponding to another processing circuit are suppressed or otherwise modified. “Maintaining audio availability” is generally used herein in the context of muting, suppressing, overwriting, or otherwise modifying audio data from a first group of processing circuits while continuing to play audio from a second group when the second group provides audio data.

The present disclosure refers to “critical” and “non-critical” processes. As used herein, these designations are indicated to the instant processing system. For example, in some implementations, these designations are indicated via a flag, based on a source of the process, or by being assigned to a processor configured to perform processes of a particular designation (e.g., a process assigned to a processor configured to perform critical processes is considered to be a critical process). As used herein, “critical” designations generally correspond to safety features used in emergency situations (e.g., connecting emergency telephone calls or playing safety chimes) and “non-critical” designations correspond to features that are not normally considered safety features (e.g., running an entertainment system).

The techniques described herein are, in different implementations, employed using any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). For ease of illustration, reference is made herein to example systems and methods in which processing circuits are employed. However, it will be understood that the systems and techniques described herein apply equally to the use of other types of parallel processors unless otherwise noted.

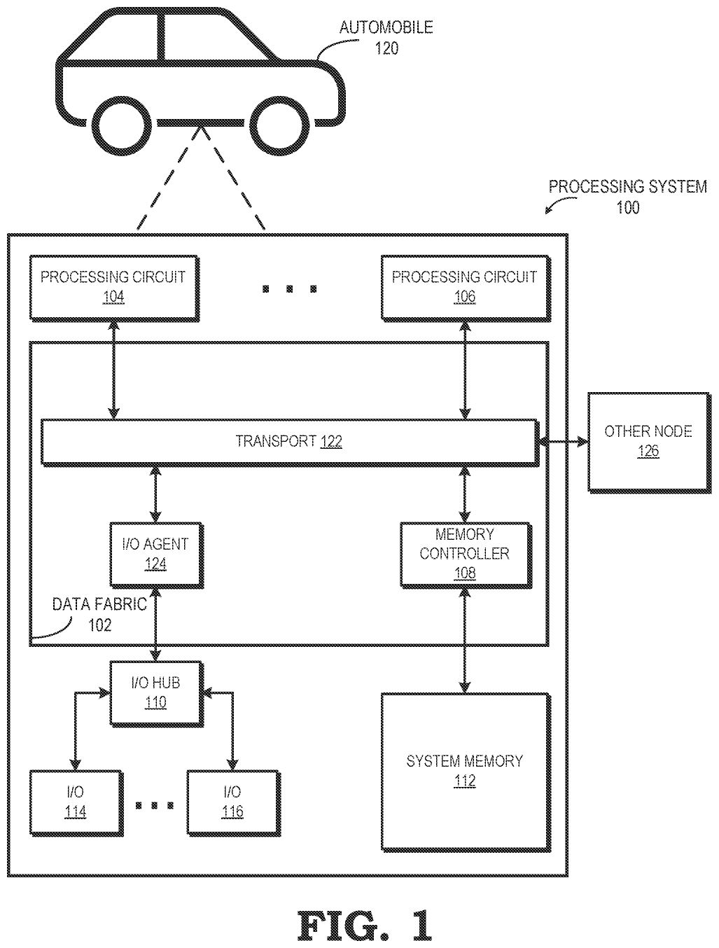

FIG. 1 illustrates a processing system 100 that includes a hardware audio modification system in accordance with at least some implementations. The processing system 100 includes a data fabric 102 used to interconnect various components of processing system 100, including a plurality of processing circuits, such as processing circuit 104 and processing circuit 106, one or more memory controllers 108, and one or more input/output (I/O) hubs 110. Each memory controller 108 is coupled to one or more memory devices such as system memory 112, and each I/O hub 110 is in turn coupled to one or more I/O devices, such as I/O devices 114-116. In some implementations, processing system 100 is incorporated into an automobile 120.

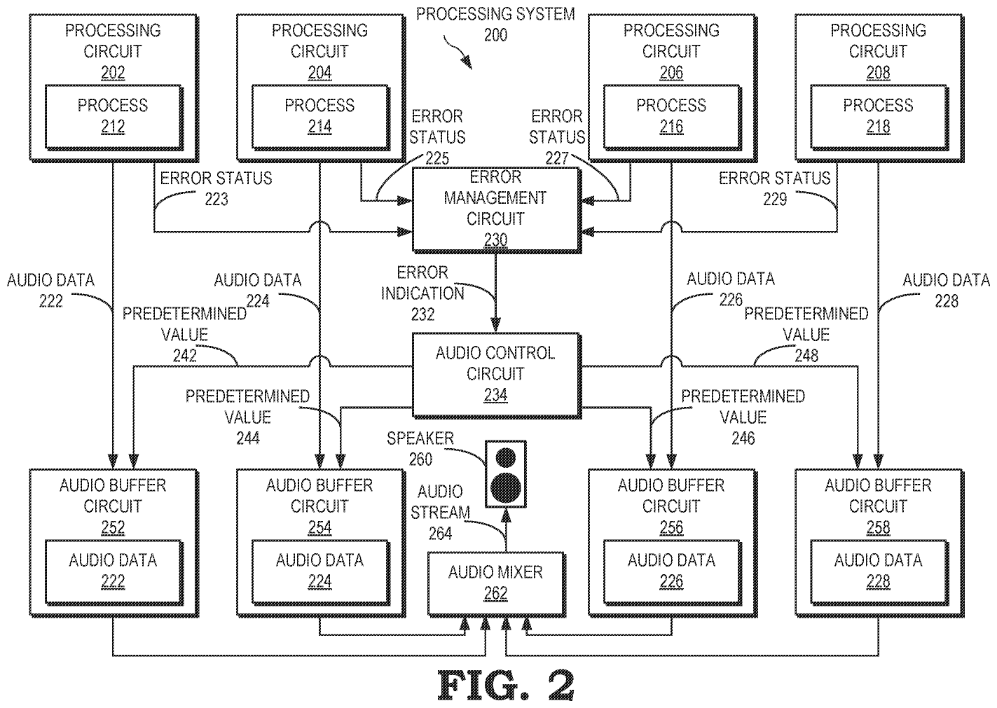

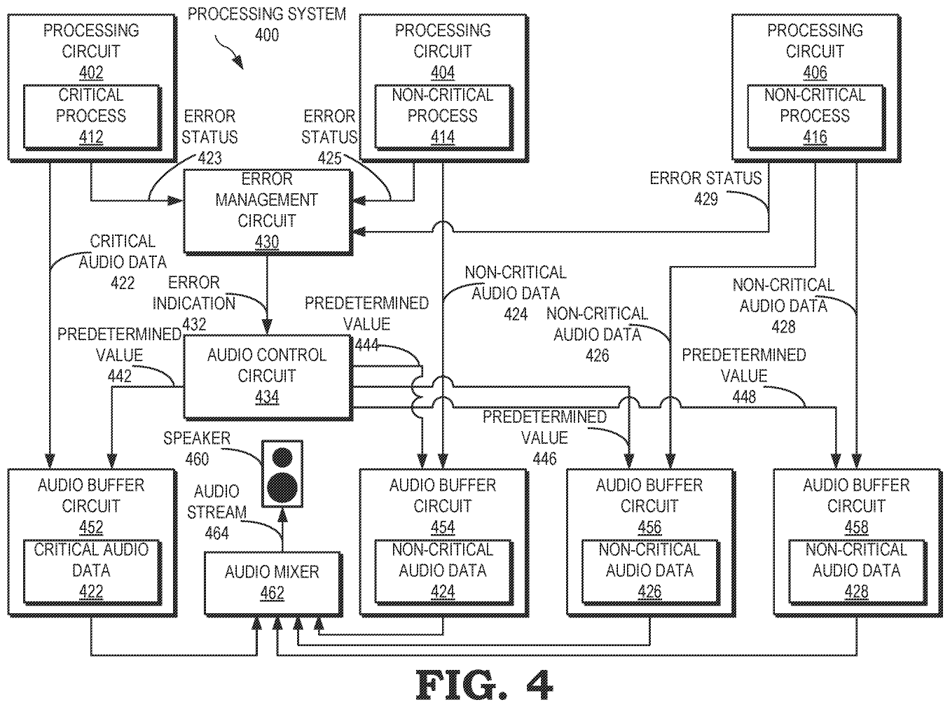

Processing circuits 104-106 include one or more processor cores. In some implementations, processor cores 104-106 include respective local cache hierarchies. In some implementations, processor cores 104-106 are, for example, central processing unit (CPU) cores, GPU cores, digital signal processor (DSP) cores, parallel processor cores, or a combination thereof. In some implementations, at least one of processing circuits 104-106 differs from at least one other of processing circuits 104-106 (i.e., processing circuits 104-106 are heterogeneous). In other implementations, processing circuits 104-106 are homogeneous. As further described below with reference to FIG. 4, in some implementations, processing circuits 104-106 are configured to perform critical processes or non-critical processes. In some implementations, the physical configuration of processing circuits 104-106 is changed to perform these processes, such as by configuring a processing circuit to enforce various deadlines as real-time deadlines or to report internal data values more frequently or more easily when configured to perform critical processes. In some implementations, one or more of processing circuits includes at least one error management circuit and at least one audio control circuit as further described below with reference to FIGS. 2-5. In some implementations, at least one error management circuit and at least one audio control circuit, which in some cases are part of a single circuit, are elsewhere in processing system, such as a separate circuit connected to data fabric 102 or part of I/O hub 110.

Memory controller 108 operates as an interface between the corresponding system memory 112 and the other components of processing system 100. In some implementations, as further described below with reference to FIGS. 2-5, system memory 112 includes a first portion that stores critical data and a second portion that stores non-critical data. In some implementations, memory controller 108 includes at least one arbiter circuit as further described below with reference to FIGS. 2-5.

I/O devices 114-116 operate to transfer data into and out of processing system 100 using direct memory access (DMA) operations. For example, in some implementations, one of I/O devices 114-116 includes a network interface card (NIC) for connecting the node to a network for receiving and transmitting data, or hard disk drive (HDD) or other mass storage device for non-volatile storage of relatively large quantities of data for use by processing circuits 104-106, and the like. In at least one implementation, I/O hub 110 manages I/O devices 114-116 and serves as an interface between data fabric 102 and I/O devices 114-116. To illustrate, in some implementations, I/O hub 110 includes a Peripheral Component Interconnect Express (PCIe) root complex so as to operate as a PCIe interconnect between I/O devices 114-116 and data fabric 102. In some implementations, I/O devices 114-116 include a speaker. As mentioned above, in some implementations, I/O hub 110 includes at least one error management circuit and at least one audio control circuit.

Data fabric 102 transports commands, data, requests, status communications, and other signaling among the other components of processing system 100, and between processing system 100 and other nodes 126. One such subset of these transport operations is the storage of data provided by the I/O devices 114-116 at system memory 112 for use by one or more of processing circuits 104-106. I/O agent 124 operates as a coherent agent for I/O hub 110 and I/O devices 114-116. Further, in some implementations, transport layer 122 is coupled to the corresponding transport layer of one or more other nodes 126 or to processing circuits 104-106 via one or more bridge components or coherent agents (not shown). In various implementations, data fabric 102 is compatible with one or more standardized interconnect specifications, such as a HyperTransport™ specification or an Infinity Fabric™ specification.

FIG. 2 is a block diagram illustrating a processing system 200 that includes an example hardware audio modification system. In the illustrated implementation, processing system 200 includes processing circuit 202, processing circuit 204, processing circuit 206, processing circuit 208, error management circuit 230, audio control circuit 234, audio buffer circuit 252, audio buffer circuit 254, audio buffer circuit 256, audio buffer circuit 258, audio mixer 262, and speaker 260. In some implementations, processing system 200 is a subset of processing system 100 of FIG. 1. For example, in some implementations, one or more of processing circuits 202-208 correspond to one or more of processing circuits 104-106 or to individual processing cores within one or more of processing circuits 104-106. In other implementations, processing system 200 corresponds to a different processing system that includes additional or fewer components than processing system 100. Although the illustrated implementation shows a specific configuration of components, in various implementations, other combinations or arrangements of components are contemplated. For example, in some implementations, processing system 200 only includes two processing circuits or two audio buffer circuits. As another example, in some implementations, error management circuit 230 is part of audio control circuit 234 instead of being separate. In some implementations, error management circuit 230 is divided between one or more of processing circuits 202-208, audio control circuit 234 is divided between one or more of audio buffer circuits 252-258, or both. Further, in some implementations, additional components such as memory circuits or additional processing circuits that control flow between processing circuits 202-208 and audio buffer circuits 252-258 are included. In some implementations, all of processing system 200 is incorporated into a single system-on-a-chip (SOC), such as a portion of an audio co-processor for applications in an automobile.

In the illustrated implementation, processing circuit 202 is running process 212, processing circuit 204 is running process 214, processing circuit 206 is running process 216, and processing circuit 208 is running process 218. In some implementations, as described below with reference to FIG. 4, processes 212-218 are either critical processes or non-critical processes. As a result of executing processes 212-218, audio data is generated. In some cases, such as audio data resulting from a process that sends a radio broadcast to speaker 260, audio data is generated continuously or periodically. In some cases, such as audio data for an impact detection process, audio data is generated on occasion, such as when a certain set of conditions are met. When audio data is generated, audio data 222 from processing circuit 202 is sent to audio buffer circuit 252, audio data 224 from processing circuit 204 is sent audio buffer circuit 254, audio data 226 from processing circuit 206 is sent to audio buffer circuit 256, audio data 228 from processing circuit 208 is sent to audio buffer circuit 258, or any combination thereof. However, in other implementations, as discussed further below with reference to FIG. 4, multiple processing circuits send audio data to be summed, interleaved, or otherwise combined into a single audio buffer circuit or a single processing circuit sends audio data to multiple audio buffer circuits. In some implementations, writes from processing circuits 202-208 to audio buffer circuits 252-258 are performed via an arbiter circuit that manages memory requests by processing circuits 202-208.

Audio buffer circuits 252-258 send stored audio data or signals based from stored audio data to audio mixer 262. Audio mixer 262 generates audio stream 264 based on the received audio data. In some implementations, audio stream 264 is an aggregation or other mixing of the received audio data, resulting in a single stream of data. Audio stream 264 is sent to speaker 260, which plays audio based on audio stream 264. In some implementations, audio mixer 262 is a hardware circuit running critical processes and distinct from audio buffer circuits 252-258. In other implementations, audio mixer 262 is incorporated into another circuit, such as one of audio buffer circuits 252-258. In some implementations, audio mixer 262 is a critical process that runs on another circuit, such as one of processing circuits 202-208 or another processing circuit such as a critical domain digital signal processor. In some implementations, one or more of audio buffer circuits 252-258 are read periodically. As a result, if a data value in an audio buffer circuit is not changed between reads, a same output is generated repeatedly. In some cases, that same output corresponds to a sound that disturbs or distracts a driver of an automobile.

Error management circuit 230 detects errors at processing circuits 202-208. In the illustrated implementation, error management circuit 230 detects errors based on error status data 223, error status data 225, error status data 227, error status data 229, or any combination thereof. Further, in some implementations, error management circuit 230 detects errors based on a processing circuit failing to respond to a periodic watchdog timer interrupt. For example, if error status data 225 indicates an error or if processing circuit 204 fails to respond to a watchdog timer interrupt, error management circuit 230 detects an error at processing circuit 204. In some implementations, the watchdog timer interrupt for one or more of processing circuits 202-208 is based on a respective threshold amount of time. In some implementations, the threshold amount of time for each of processing circuits 202-208 is different from each other threshold amount of time. In other implementations, the threshold amount of time for one of processing circuits 202-208 is the same as the threshold amount of time for at least one other processing circuit of processing circuits 202-208.

In response to detecting an error, error management circuit 230 sends error indication 232 to audio control circuit 234 indicating the processing circuit or circuits experiencing the error. In response to receiving error indication 232, audio control circuit 234 writes one or more predetermined values to audio buffer circuits 252-258, overwriting some or all previously stored audio data. For example, in response to receiving an indication of an error at processing circuit 202, audio control circuit 234 sends predetermined value 242 to audio buffer circuit 252. In response to receiving an indication of an error at processing circuit 204, audio control circuit 234 sends predetermined value 244 to audio buffer circuit 254. In response to receiving an indication of an error at processing circuit 206, audio control circuit 234 sends predetermined value 246 to audio buffer circuit 256. In response to receiving an indication of an error at processing circuit 208, audio control circuit 234 sends predetermined value 248 to audio buffer circuit 258. In some implementations, one or more of predetermined values 242-248 are zero, zero-filling one or more of audio buffer circuits 252-258. In some cases, zero-filling an audio buffer circuit causes audio from corresponding processing circuits to be muted. In some cases, writing another data value to an audio buffer circuit causes the audio from corresponding processing circuits to be muted. In some implementations, a predetermined pattern is an alert data value corresponding to a user alert sound that alerts a user to the detected error.

Because audio data corresponding to a detected error is modified by the predetermined value, audio corresponding to previously written audio data is suppressed while maintaining audio availability for other processing circuits in processing system 200.

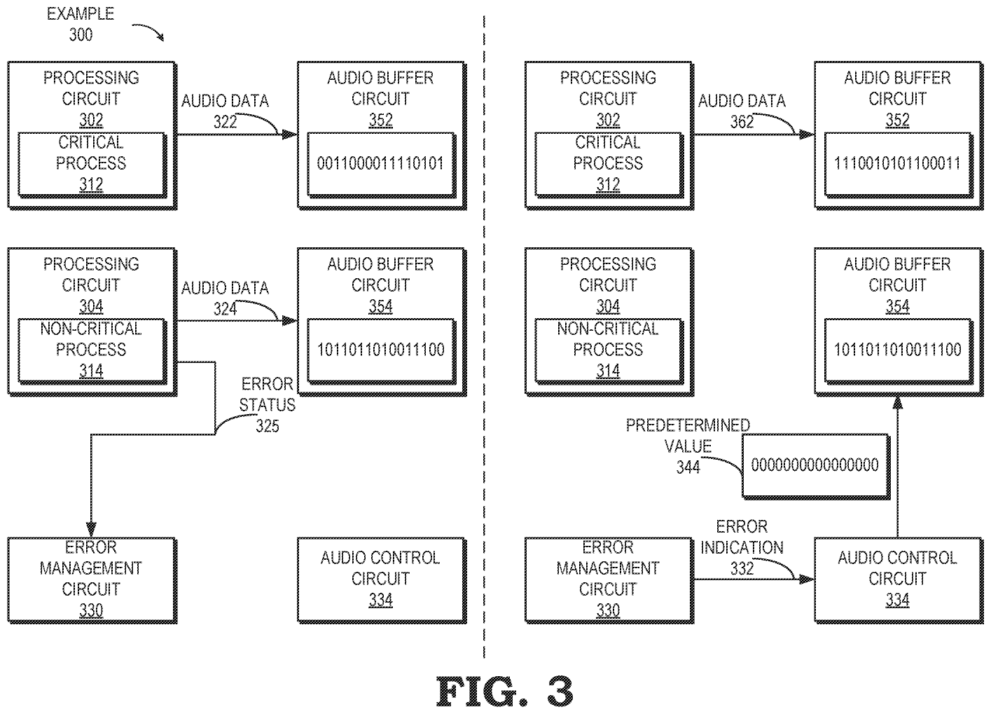

FIG. 3 is a block diagram showing an example 300 modification of audio data in a hardware audio modification system. The left side of FIG. 3 illustrates normal operation of a processing system of a hardware audio modification system. The right side of FIG. 3 corresponds to actions performed at the processing system as an error corresponding to processing circuit 304 is detected. In some implementations, processing circuits 302 and 304 correspond to two processing circuits of processing circuits 202-208 of FIG. 2, audio buffer circuits 352 and 354 correspond to two audio buffer circuits 252-258, error management circuit 330 corresponds to error management circuit 230, and audio control circuit 334 corresponds to audio control circuit 234.

In example 300, processing circuit 302 is running critical process 312 and processing circuit 304 is running non-critical process 314. Processing circuit 302 sends audio data 322 with a value of 0011000011110101 to audio buffer circuit 352 and error status data to error management circuit 330 (not shown). Processing circuit 304 sends audio data 324 with a value of 1011011010011100 to audio buffer circuit 354 and error status data 325 to error management circuit 330. In various implementations, the error status data is one or more of control signals, status signals, or responses watchdog timer interrupts.

Subsequently, processing circuit 302 sends audio data 362 with a value of 1110010101100011 to audio buffer circuit 352, replacing audio data 322, and sends error status data to error management circuit 330. However, processing circuit 304 experiences an error and new audio data is not sent to audio buffer circuit 354. Error management circuit 330 detects the error based on receiving error status data indicative of the error or based on processing circuit 304 failing to respond to a watchdog timer interrupt from error management circuit 330. In response to detecting the error, error management circuit 330 sends error indication 332 to audio control circuit 334. Audio control circuit 334 sends predetermined value 344 with a value of 0000000000000000 to audio buffer circuit 354, overwriting audio data 324. Accordingly, audio buffer circuit 354 is prevented from repeatedly sending audio data 324 to a speaker.

Although data values in example 300 have 16-bit values, in other implementations, data values have larger or smaller values. In other implementations, predetermined value 344 has a different value corresponding to muting output of an audio buffer circuit or corresponding to a user alert about the error at processing circuit 304.

FIG. 4 a block diagram illustrating a processing system 400 that includes a second example hardware audio modification system. In the illustrated implementation, processing system 400 includes processing circuit 402, processing circuit 404, processing circuit 406, error management circuit 430, audio control circuit 434, audio buffer circuit 452, audio buffer circuit 454, audio buffer circuit 456, audio buffer circuit 458, audio mixer 462, and speaker 460. In some implementations, processing system 400 is a subset of processing system 100 of FIG. 1 or a subset of processing system 200 of FIG. 2. For example, in some implementations, one or more of processing circuits 402-406 correspond to one or more of processing circuits 104-106 or to individual processing cores within one or more of processing circuits 104-106. As another example, in some implementations, processing circuits 402-406 correspond to processing circuits 202-206 of FIG. 2. In other implementations, processing system 400 corresponds to a different processing system that includes additional or fewer components than processing system 100, processing system 200, or both. Although the illustrated implementation shows a specific configuration of components, in various implementations, other combinations or arrangements of components are contemplated. For example, in some implementations, processing system 400 only includes two processing circuits or two audio buffer circuits. As another example, in some implementations, error management circuit 430 is part of audio control circuit 434 instead of being separate. In some implementations, audio mixer 462 is part of an audio buffer circuit (e.g., audio buffer circuit 458) or a processing circuit (e.g., processing circuit 404). In some implementations, error management circuit 430 is divided between one or more of processing circuits 402-406, audio control circuit 434 is divided between one or more of audio buffer circuits 452-458, or both. Further, in some implementations, additional components such as memory circuits or additional processing circuits that control flow between processing circuits 402-406 and audio buffer circuits 452-458 are included. In some implementations, all of processing system 400 is incorporated into a single system-on-a-chip (SOC), such as a portion of an audio co-processor for applications in an automobile.

In the illustrated implementation, processing circuit 402 is running critical process 412, processing circuit 404 is running non-critical process 414, and processing circuit 406 is running non-critical process 416. As a result of executing critical process 412 and non-critical processes 414 and 416, audio data is generated. In some cases, such as audio data resulting from a process that sends a radio broadcast to speaker 460, audio data is generated continuously or periodically. In some cases, such as audio data for an impact detection process, audio data is generated on occasion, such as when a certain set of conditions are met. When audio data is generated, critical audio data 422 from processing circuit 402 is sent to audio buffer circuit 452. When audio data is generated, non-critical audio data 424 from processing circuit 404 is sent to audio buffer circuit 454. Processing circuit 406 generates two streams of audio data, non-critical audio data 426, which is sent to audio buffer circuit 456, and non-critical audio data 428, which is sent to audio buffer circuit 458. However, in other implementations, each processing circuit has its own respective audio buffer circuit or multiple processing circuits send audio data to be summed, interleaved, or otherwise combined into a single audio buffer circuit. In some implementations, writes from processing circuits 402-406 to audio buffer circuits 452-458 are performed via an arbiter circuit that manages memory requests by processing circuits 402-408.

Audio buffer circuits 452-458 send stored audio data or signals based from stored audio data to audio mixer 462. Audio mixer 462 generates audio stream 464 based on the received audio data. In some implementations, audio stream 464 is an aggregation or other mixing of the received audio data, resulting in a single stream of data. Audio stream 464 is sent to speaker 460, which plays audio based on audio stream 464. In some implementations, audio mixer is a hardware circuit running critical processes and distinct from audio buffer circuits 452-458. In other implementations, audio mixer 462 is incorporated into another circuit, such as one of audio buffer circuits 452-458. In some implementations, audio mixer 462 is a critical process that runs on another circuit, such as one of processing circuits 402-206 or another processing circuit such as a critical domain digital signal processor. In some implementations, one or more of audio buffer circuits 452-458 are read periodically. As a result, if a data value in an audio buffer circuit is not changed between reads, a same output is generated repeatedly. In some cases, that same output corresponds to a sound that disturbs or distracts a driver of an automobile.

Error management circuit 430 detects errors at processing circuits 402-406. In the illustrated implementation, error management circuit 430 detects errors based on error status data 423, error status data 425, error status data 429, or any combination thereof. For example, if error status data 425 indicates an error or if processing circuit 404 fails to respond to a watchdog timer interrupt, error management circuit 430 detects an error at processing circuit 404. In some implementations, the watchdog timer interrupt for one or more of processing circuits 402-406 is based on a respective threshold amount of time. In some implementations, the threshold amount of time for each of processing circuits 402-406 is different from each other threshold amount of time. In other implementations, the threshold amount of time for one of processing circuits 402-406 is the same as the threshold amount of time for at least one other processing circuit of processing circuits 402-406.

In response to detecting an error, error management circuit 430 sends error indication 432 to audio control circuit 434 indicating the processing circuit or circuits experiencing the error. In response to receiving error indication 432, audio control circuit 434 writes one or more predetermined values to audio buffer circuits 452-458, overwriting some or all previously stored audio data. For example, in response to receiving an indication of an error at processing circuit 402, audio control circuit 434 sends predetermined value 442 to audio buffer circuit 452. In response to receiving an indication of an error at processing circuit 404, audio control circuit 434 sends predetermined value 444 to audio buffer circuit 454. In response to receiving an indication of an error at processing circuit 406, audio control circuit 434 sends predetermined value 446 to audio buffer circuit 456 and predetermined value 448 to audio buffer circuit 458. In some implementations, one or more of predetermined values 442-448 are zero, zero-filling one or more of audio buffer circuits 452-458. In some cases, zero-filling an audio buffer circuit causes audio from corresponding processing circuits to be muted. In some cases, writing another data value to an audio buffer circuit causes the audio from corresponding processing circuits to be muted. In some implementations, a predetermined pattern is an alert data value corresponding to a user alert sound that alerts a user to the detected error.

In various implementations, critical processes include making a sound when a door of an automobile is open, displaying a speedometer, connecting audio of an emergency telephone call to at least one speaker of the automobile, enabling a turn signal of the automobile, enabling headlights of the automobile, making a sound to alert pedestrians to a location of the automobile, or any combination thereof. In various implementations, non-critical processes include connecting radio audio to at least one speaker of an automobile, connecting audio of a non-emergency telephone call to at least one speaker of the automobile, activating a display of an entertainment system of the automobile, or any combination thereof.

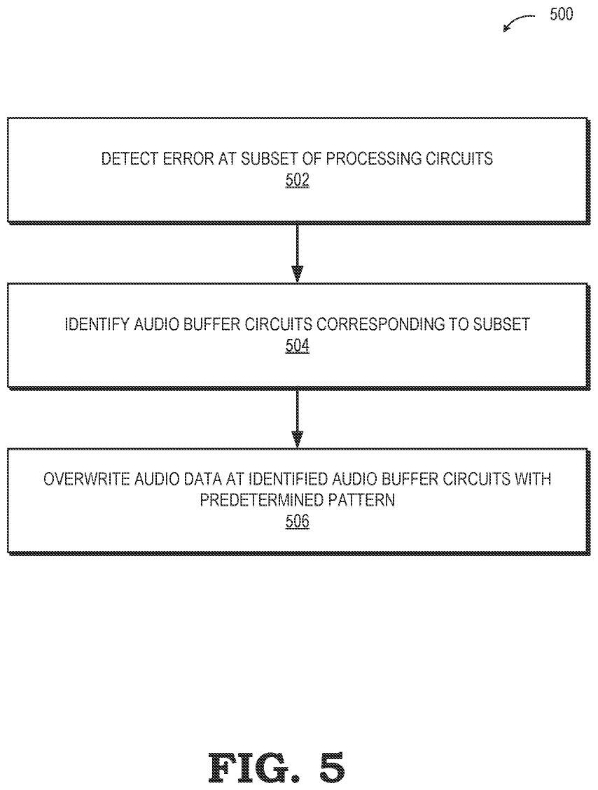

FIG. 5 is a flow diagram illustrating a method 500 of modifying audio in accordance with some implementations. In some implementations, various portions are performed in another order. For example, in some implementations, a determination of whether a processing circuit is performing a critical or non-critical process is performed before a determination of whether a memory request addresses critical data. In some implementations, method 500 is initiated by one or more processors in response to one or more instructions stored by a computer readable storage medium.

At block 502, an error at a subset of processing circuits is detected. For example, audio control circuit 234 of FIG. 2 detects an error at processing circuit 206 via error indication 232. At block 504, audio buffer circuits corresponding to the subset are identified. For example, audio control circuit 234 identifies audio buffer circuit 256 as corresponding to processing circuit 206. At block 506, audio data at the identified audio buffer circuits is overwritten with a predetermined pattern. For example, audio control circuit 234 overwrites audio data 226 at audio buffer circuit 256 with predetermined value 246. As a result of overwriting audio data 226 with predetermined value 246, audio at speaker 260 via audio stream 264 from audio buffer circuit 256 is modified but audio via audio stream 264 from audio buffer circuit 252 is not modified. Accordingly, a method of modifying audio is depicted.

In some implementations, a computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), or Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. In some implementations, the computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. In some implementations, the executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device are not required, and that, in some cases, one or more further activities are performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that cause any benefit, advantage, or solution to occur or become more pronounced are not to be construed as a critical, required, or essential feature of any or all the claims. Moreover, the particular implementations disclosed above are illustrative only, as the disclosed subject matter could be modified and practiced in different but equivalent manners apparent to those skilled in the art having the benefit of the teachings herein. No limitations are intended to the details of construction or design shown herein, other than as described in the claims below. It is therefore evident that the particular implementations disclosed above could be altered or modified and all such variations are considered within the scope of the disclosed subject matter. Accordingly, the protection sought herein is as set forth in the claims below.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

What is claimed is:

1. A system comprising:
an error management circuit configured to detect an error at a first subset of a plurality of processing circuits, wherein the error is not detected at a second subset of the plurality of processing circuits, and wherein each of the plurality of processing circuits produces audio data; and
an audio control circuit configured to mute the first subset in response to receiving an indication of the error while maintaining audio availability of the second subset.

2. The system of claim 1, further comprising:
a plurality of audio buffer circuits configured to store audio data from the plurality of processing circuits.

3. The system of claim 2, wherein muting the first subset comprises writing a predetermined value into one or more audio buffer circuits corresponding to the first subset.

4. The system of claim 3, further comprising:
a speaker configured to play an audio stream generated based on the audio data stored at the plurality of audio buffer circuits.

5. The system of claim 3, wherein writing the predetermined value comprises zero-filling the one or more audio buffer circuits.

6. The system of claim 2, wherein detecting the error comprises determining that the first subset has not written new audio data to the plurality of audio buffer circuits within a threshold amount of time.

7. The system of claim 1, wherein the first subset generates non-critical audio data and wherein the second subset generates critical audio data.

8. The system of claim 7, wherein the plurality of processing circuits are integrated into an automobile, wherein the non-critical audio data comprises radio audio data, non-emergency telephone data, or both, and wherein the critical audio data comprises safety chime data, emergency telephone data, or both.

9. The system of claim 1, wherein the plurality of processing circuits, the error management circuit, and the audio control circuit are integrated together into a system-on-a-chip (SOC).

10. A method, comprising:
receiving, at an audio control circuit, an indication of an error at a first subset of a plurality of processing circuits, wherein the error is not indicated at a second subset of the plurality of processing circuits; and
overwriting audio data from the first subset with one or more predetermined values at one or more audio buffer circuits corresponding to the first subset.

11. The method of claim 10, further comprising:
subsequent to overwriting the audio data from the first subset, causing a sound corresponding to audio data from the second subset to be played.

12. The method of claim 11, wherein the audio data from the first subset is non-critical audio data and the audio data from the second subset is critical audio data.

13. The method of claim 12, wherein the sound comprises a safety chime, emergency telephone audio, an emergency radio broadcast, or any combination thereof.

14. The method of claim 10, wherein overwriting the audio data with the one or more predetermined values at the one or more audio buffer circuits comprises zero-filling the one or more audio buffer circuits.

15. The method of claim 10, wherein overwriting one or more audio data values with the one or more predetermined values at the one or more audio buffer circuits comprises writing an alert data value corresponding to a user alert sound.

16. An apparatus, comprising:
a plurality of audio buffer circuits configured to store audio data from a plurality of processing circuits; and
an audio control circuit configured to overwrite audio data from a first subset of the plurality of processing circuits in response to receiving an indication of an error at the first subset and while maintaining audio availability of audio data from a second subset of the plurality of processing circuits.

17. The apparatus of claim 16, further comprising:
an error management circuit configured to detect the error at the first subset of the plurality of processing circuits, wherein the error is not detected at the second subset of the plurality of processing circuits.

18. The apparatus of claim 17, wherein detecting the error comprises determining that the first subset has not responded to a watchdog timer interrupt within a threshold amount of time.

19. The apparatus of claim 16, wherein overwriting the audio data comprises writing a predetermined value into one or more of the audio buffer circuits storing the audio data from the first subset.

20. The apparatus of claim 19, wherein writing the predetermined value comprises zero-filling the one or more audio buffer circuits.
